(19) United States
(12) Patent Application Publication
(10) Pub. No.: US 2022/0386165 A1
(43) Pub. Date: Dec. 1, 2022

(54) METHOD OF WIRELESS COMMUNICATION SYSTEM FOR EXTENDED REALITY APPLICATIONS WITH ENHANCED QUALITY OF SERVICE

(71) Applicant: INSTITUTE FOR INFORMATION INDUSTRY, TAIPEI (TW)

(72) Inventor: Shu-Tsz LIU, TAIPEI (TW)

(21) Appl. No.: 17/818,978

(22) Filed: Aug. 11, 2022

Related U.S. Application Data
(63) Continuation-in-part of application No. 17/454,613, filed on Nov. 11, 2021.
(60) Provisional application No. 63/136,651, filed on Jan. 13, 2021.

(51) Int. Cl. H04W 28/02; H04W 76/14; H04L 1/18

(52) U.S. Cl. CPC H04W 28/0268; H04W 76/14; H04L 1/189

(57) ABSTRACT

A method of a wireless communication system for extended reality (XR) applications is disclosed. The method includes: triggering a service reliability procedure with activating an XR-specific handling procedure in response to a first network condition; and determining whether to perform a protocol layer quality of service (QoS) handling mechanism with XR-specific handling consideration, a physical layer QoS handling mechanism with XR-specific handling consideration, or a physical layer QoS handling mechanism without XR-specific handling consideration to enhance QoS between a network and a mobile terminal depending on a QoS requirement for XR data transmissions.

### RELATED APPLICATIONS

This application is a continuation-in-part application of the U.S. application Ser. No. 17/454,613 filed Nov. 11, 2021, which claims priority to U.S. Provisional Application Ser. No. 63/136,651 filed Jan. 13, 2021, the entirety of which is incorporated by reference herein.

### BACKGROUND

### Field of the Invention

The disclosure relates to wireless communication technology, and more particularly to a method of a wireless communication system for extended reality (hereinafter abbreviated as “XR”) applications with enhanced quality of service (QoS).

### Description of Related Art

5G New Radio (NR) is a recently developed radio access technology that supports high throughput and low latency as well as large capacity communications. In addition, extended reality (XR) applications, such as virtual reality (VR), augmented reality (AR), mixed reality (MR) and/or the like, have been progressively developed in recent years, and have been being adopted in a variety of real-time applications, such as industrial applications, medical applications and educational applications. For industrial applications adopting 5G NR technology as well as XR application services, such as man-machine coexistence, automated production, and so on, different connection recovery times are required when a connection error occurs. In particular, some applications (e.g. motion control and on board control) in automation technology require shorter connection recovery times. Therefore, how to quickly recover connections for certain specific applications to ensure normal operations has become an important issue for real-time applications adopting XR services.

### SUMMARY

The disclosure directs to a method of a wireless communication system for extended reality (XR) applications. The method includes: triggering a service reliability procedure with activating an XR-specific handling procedure in response to a first network condition; and determining whether to perform a protocol layer quality of service (QoS) handling mechanism with XR-specific handling consideration, a physical layer QoS handling mechanism with XR-specific handling consideration, or a physical layer QoS handling mechanism without XR-specific handling consideration to enhance QoS between a network and a mobile terminal depending on a QoS requirement for XR data transmissions.

In accordance with one or more embodiments of the disclosure, performing the protocol layer QoS handling mechanism with XR-specific handling consideration includes: activating, at the mobile terminal, a radio link control (RLC) entity for a packet data convergence protocol (PDCP) duplication; and determining, by the mobile terminal, whether a configured grant (CG) resource allocated nearby the mobile terminal is available for use within the QoS requirement for XR data transmissions, and if yes, utilizing the CG resource to perform a PDCP retransmission or transmission; otherwise, sending an uplink (UL) grant message to the network to ask for a dynamic grant (DG) resource to perform a PDCP retransmission or transmission.

In accordance with one or more embodiments of the disclosure, performing the protocol layer QoS handling mechanism with XR-specific handling consideration further includes: sending, by the network, a media access control (MAC) control element (CE) to the mobile terminal for activating the RLC entity in response to the first network condition.

In accordance with one or more embodiments of the disclosure, the MAC CE is extended based on CG/SPS configurations MAC CE or PDCP duplication MAC CE for indicating to support the QoS requirement.

In accordance with one or more embodiments of the disclosure, the method further includes: stopping, by the mobile terminal, the PDCP duplication in response to a second network condition.

In accordance with one or more embodiments of the disclosure, the method further includes: sending, by the network, a MAC CE to the mobile terminal for stopping the PDCP duplication in response to the second network condition.

In accordance with one or more embodiments of the disclosure, the network sends a radio resource control (RRC) message to the mobile terminal for deactivating the PDCP duplication in response to a third network condition.

In accordance with one or more embodiments of the disclosure, XR-awareness information for the protocol layer QoS handling mechanism with XR-specific handling consideration comprises XR data periodicity, XR data size, XR data frame type, XR data identity, XR data level QoS parameters, number of PDUs for XR data, 5G QoS Indicators (5QI) or jitter information.

In accordance with one or more embodiments of the disclosure, performing the physical layer QoS handling mechanism with XR-specific handling consideration includes applying physical layer repetition to retransmit or transmit XR data.

In accordance with one or more embodiments of the disclosure, the physical layer repetition includes at least one of CG physical uplink shared channel (PUSCH) repetition, DG PUSCH repetition or resource block (RB) repetition.

In accordance with one or more embodiments of the disclosure, performing the physical layer QoS handling mechanism with XR-specific handling consideration includes modifying a modulation and coding scheme (MCS) indication to retransmit or transmit XR data.

In accordance with one or more embodiments of the disclosure, performing the physical layer QoS handling mechanism includes performing Bandwidth Part (BWP) switching and/or beam sweeping on the mobile terminal and/or the network to retransmit or transmit XR data.

In accordance with one or more embodiments of the disclosure, performing the physical layer QoS handling mechanism with XR-specific handling consideration includes using one or more mini-slots or adjusting a transmission time interval (TTI) to retransmit or transmit specific XR data.

In accordance with one or more embodiments of the disclosure, performing the physical layer QoS handling mechanism includes utilizing frequency hopping, multi-input multi-output (MIMO), non-orthogonal multiple access (NOMA), or uplink preemption to retransmit or transmit a data packet for high priority transmission.

In accordance with one or more embodiments of the disclosure, the method further includes: utilizing a MAC Protocol Data Unit (PDU) with an extended logical channel ID (eLCID) value for a Downlink Shared Channel (DL-SCH) or an uplink shared channel (UL-SCH) for supporting activation and deactivation of the service reliability procedure.

In accordance with one or more embodiments of the disclosure, the method further includes: determining whether a current protocol layer scheduling procedure meets the QoS requirement for specific XR data with tight delay budget, and if yes, using the current protocol layer scheduling procedure for the specific XR data without adjusting the protocol layer QoS handling mechanism; otherwise, changing the protocol layer QoS handling mechanism to schedule the specific XR data first or to utilize a higher priority for the specific XR data.

In accordance with one or more embodiments of the disclosure, the method further includes: determining whether a current MAC scheduling procedure with a higher priority meets the QoS requirement for specific XR data, and if yes, assigning a higher MAC priority for the specific XR data; otherwise, assigning a higher physical layer priority for the specific XR data.

In accordance with one or more embodiments of the disclosure, the method further includes: configuring user equipment (UE) capability information to support the QoS requirement for XR data transmissions during the service reliability procedure.

In accordance with one or more embodiments of the disclosure, the method further includes: adjusting a TTI, a periodicity or a priority, or enabling physical layer repetition and/or MCS for packet transmissions during the service reliability procedure.

In accordance with one or more embodiments of the disclosure, triggering the service reliability procedure includes: sending, from the mobile terminal, an RRC message to the network for indicating that the mobile terminal supports the QoS requirement for XR data transmissions; and adding or modifying, at the network, a resource allocation configuration to support the QoS requirement for XR data transmissions.

### BRIEF DESCRIPTION OF THE DRAWINGS

The foregoing aspects and many of the accompanying advantages of this disclosure will become more readily appreciated as the same becomes better understood by reference to the following detailed description, when taken in conjunction with the accompanying drawings.

FIG. 1 is a schematic diagram of an extended reality (XR) system in accordance with some embodiments of the disclosure.

FIG. 2 illustratively shows an example of message transmissions from a source terminal to a target terminal through a network.

FIG. 3 is a flowchart illustrating a method of a wireless communication system for XR applications with enhanced quality of service (QoS) in accordance with some embodiments of the disclosure.

FIG. 4 is a flowchart illustrating a method of an initial configuration at the mobile terminal for the service reliability procedure in accordance with some embodiments of the disclosure.

FIG. 5 is a flowchart illustrating a method of an initial configuration at the network for the service reliability procedure in accordance with some embodiments of the disclosure.

FIG. 6 is a flowchart illustrating a method of a protocol layer QoS handling mechanism with XR-specific handling consideration during XR data transmissions in accordance with some embodiments of the disclosure.

FIG. 7 is flowchart illustrating a method of handling XR data transmissions for some exemplary examples.

FIG. 8 is a flowchart illustrating a method of a wireless communication system for XR applications with enhanced QoS in accordance with some alternative embodiments of the disclosure.

FIG. 9 is a flowchart illustrating a method of a network control based packet data convergence protocol (PDCP) duplication procedure in accordance with some embodiments of the disclosure.

FIG. 10 is a flowchart illustrating a method of a UE control based PDCP duplication procedure in accordance with some embodiments of the disclosure.

FIG. 11 is a block diagram of an apparatus in accordance with some embodiments of the disclosure.

### DETAILED DESCRIPTION

The detailed explanation of the disclosure is described as following. The described preferred embodiments are presented for purposes of illustrations and description, and they are not intended to limit the scope of the disclosure.

Terms used herein are only used to describe the specific embodiments, which are not used to limit the claims appended herewith. Unless limited otherwise, the term “a,” “an,” “one” or “the” of the single form may also represent the plural form.

It will be understood that, although the terms “first,” “second,” “third” . . . etc., may be used herein to describe various elements and/or components, these elements and/or components, should not be limited by these terms. These terms are only used to distinguish elements and/or components.

The term “XR data” herein may be, for example, a protocol data unit (PDU) or a set of PDUs (e.g. in a frame) including data for XR, or may be a new payload format dedicated to XR data transmissions.

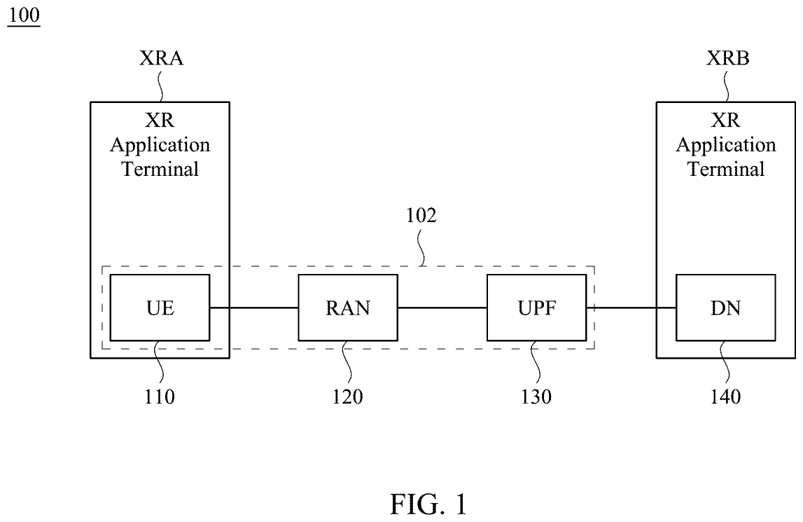

Referring to FIG. 1, which exemplarily illustrates a schematic diagram of an XR system 100 in accordance with some embodiments of the disclosure. The XR system 100 may support various types of XR applications, such as VR, AR, MR and/or beyond. As shown in FIG. 1, a wireless communication system 102 is involved in the XR system 100. The wireless communication system 102 may be a wireless communication system, such as 5G New Radio (NR), beyond 5G, Industrial Internet of Things (IIoT) and/or any other similar wireless communication system. In the wireless communication system 102, a user equipment (UE, also referred to as a mobile terminal) 110 and a radio access network (RAN) 120 are communicatively connected through an air interface. The UE 110 may be a smartphone, a tablet, a VR headset, AR/MR glasses, or another apparatus with XR function(s) and capable of communicatively connecting the RAN 120 in the wireless communication system 102. The RAN 120 may include one or more base stations accessible to the UE 110 via the air interface. In addition to the RAN 120, the wireless communication system 102 includes a core network part for serving the UE 110. The core network part may include a user plane function (UPF) 130 and other functional eneity(ies) such as accessible and mobility function (AMF), authentication server function (AUSF), session management function (SMF), unified data management (UDM), policy and control function (PCF), network repository function (NRF), a data network (DN) and/or another entity for providing core network functions. The UPF 130 is communicatively connected to the RAN 120 and a DN 140 external to the wireless communication system 102, and is configured as a gateway for facilitating user plane operations, such as traffic routing, packet forwarding, and so on. In a case of 5G NR communication system integrated with 5G-XR functions, the UE 110 may be a part of an XR application terminal XRA (or may be an XR application terminal XRA) that includes an XR client (e.g. an XR device) dedicated to XR services, and the DN 140 may be a part of an XR application terminal XRB (or may be an XR application terminal XRB) that includes an XR application server as an XR application provider for providing XR application services for the UE 110. In a case of 5G NR system, the core network part in the wireless communication system 102 is also referred to as 5G Core (5GC) Network or 4G Evolved Packet Core (EPC) supporting 5G functionalities, the base stations in the RAN 120 are also referred to as Next Generation NodeBs (gNBs), Evolved Universal Terrestrial Radio Access (E-UTRA) gNBs (en-gNBs) or next generation eNodeBs (ng-eNBs), and the radio access network may be referred to as Next Generation Radio Access Network (NG-RAN) or Evolved Universal Terrestrial Radio Access Network (E-UTRAN) supporting 5G functionalities.

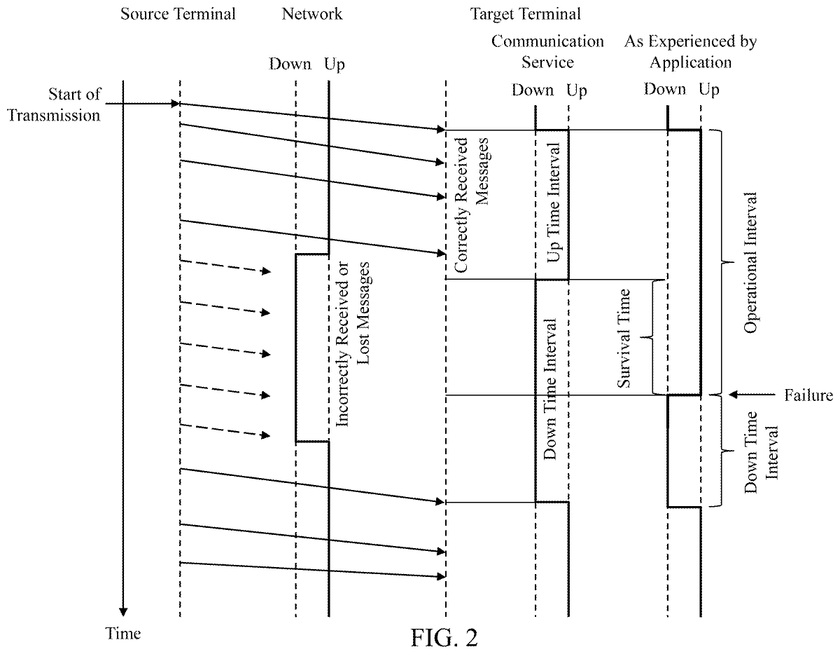

FIG. 2 illustratively shows an example of message transmissions from a source terminal to a target terminal through a network. In FIG. 2, the source terminal and the target terminal may be respectively similar to the UE 110 and the DN 140 in FIG. 1 (and vice versa), and the network may be the network side (opposite to the UE 110) of the wireless communication system 102 in FIG. 1. However, the disclosure is not limited thereto. In another example, the source terminal and the target terminal may be two UEs (e.g. the UE 110 and another UE in the same wireless communication system 102 or in different wireless communication systems) communicating with each other through the network. When the network is in an up state and runs normally, and the messages from the source terminal are correctly received by the target terminal with a running application (e.g. an XR application). The communication service of the target terminal is also in an up state from the point of view of the running application. In a condition where the network transits into a down state (e.g. due to no longer supporting end-to-end transmissions of the messages from the source terminal to the target terminal according to the negotiated communication requirements), the messages (e.g. with XR data) from the source terminal would be lost or could not be correctly received by the target terminal. Once sensing the absence of expected messages, the application on the target terminal still waits for a survival time before it determines the communication service to be unavailable. The survival time may be expressed as a period or, especially with cyclic traffic, as maximum number of consecutive incorrectly received or lost messages. If the communication service receives messages from the source terminal before the survival time is exceeded, the application may stop the survival time, and the service is not interrupted. Otherwise, if the survival time is exceeded, the application transits the status of the communication service into a down state. The application may take a particular action for handling such situations of unavailable communication services. For instance, the application will commence an emergency shutdown. It is noted that the particular action does not imply that the target application is shut off. Rather, the application on the target terminal still listens to incoming packets, or may try to send messages to the source application on the source terminal. Once the network transits back into the up state, the communication service state as perceived by the application of the target terminal changes to the up state, and is thus again perceived as available. However, for the example shown in FIG. 2, the service is interrupted after the survival time is exceeded and before the communication service of the target terminal changes to the up state.

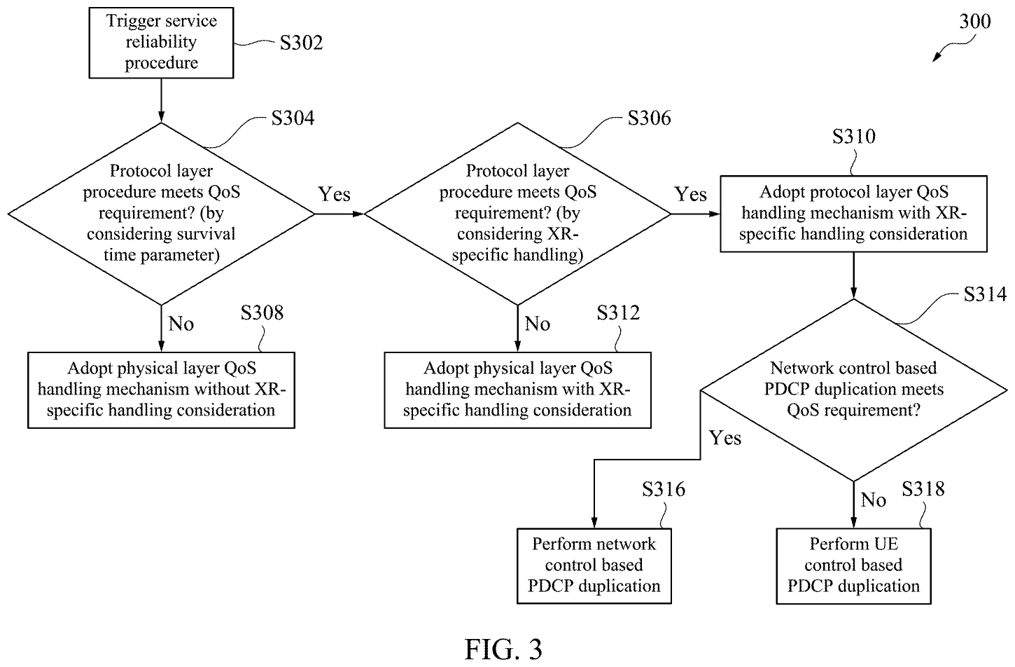

FIG. 3 is a flowchart illustrating a method 300 of a wireless communication system (e.g. the wireless communication system 102) for XR applications with enhanced QoS in order to avoid service interruptions due to survival time exceeded in accordance with some embodiments of the disclosure. In Step S302, a service reliability procedure is triggered in response to a first network condition. An XR-specific handling procedure is activated while triggering the service reliability procedure. The first network condition may be, for example, an incorrect packet or a number of consecutive incorrect XR packets received by the network, or an XR packet is lost or a number of consecutive XR packets are lost and not received by the network. In addition, the service reliability procedure may be triggered by sending a radio resource control (RRC) message from the mobile terminal to the network.

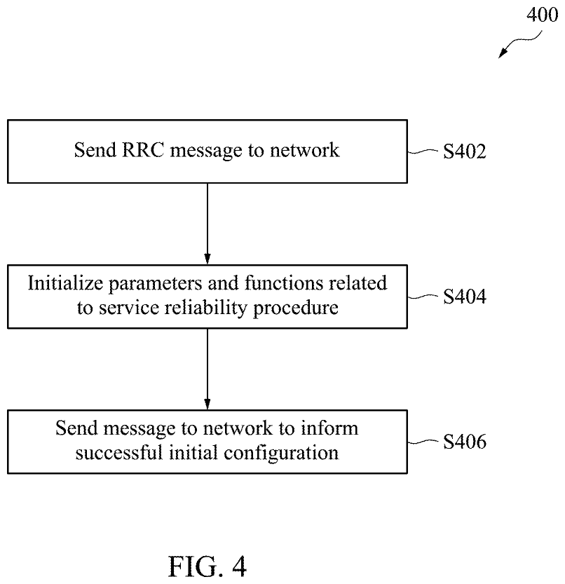

FIG. 4 is a flowchart illustrating a method 400 of an initial configuration at the mobile terminal for the service reliability procedure in accordance with some embodiments of the disclosure. In Step S402, the mobile terminal sends an RRC message to the network for indicating that the mobile terminal supports a QoS requirement for XR data transmissions. The RRC message may be an RRC setup message with UE capability information, an RRC resume message with UE capability information, an RRC reconfiguration message with UE capability information, an RRC UE capability information message, an RRC UL information transfer message, or the like. In some embodiments, the RRC message sent by the mobile terminal in Step S402 is a new RRC message other than those described above. In Step S404, the mobile terminal initializes the parameters and functions related to the service reliability procedure to support the QoS requirement procedure, such as supported QoS features related to survival time requirements, supported survival times, real-time and/or overall XR downlink (DL) and uplink (UL) traffic characteristics, real-time and/or overall XR related QoS metrics (e.g. priorities and/or delay budgets), XR application layer attributes (e.g. frame types), hybrid automatic repeat and request (HARQ) capabilities, PDCP duplication capabilities, scheduling related parameters, UE physical layer capabilities, and/or the like. The mobile terminal may obtain relative information from the network for the initiation of the parameters and functions if needed. The relative information may be, such as data radio bearer (DRB), configured grant (CG) or dynamic grant (DG) allocation for the mobile terminal, logical channel (LCH) configurations, radio link control (RLC) entity(ies), an initial value for indicating whether to activate PDCP duplications, physical layer configurations, media access control (MAC) layer configurations and/or RRC layer configurations, and/or the like. In Step S406, the mobile terminal sends a message to the network to inform that it successfully accomplishes the initial configuration. Steps S404 and S406 may be optional for some embodiments.

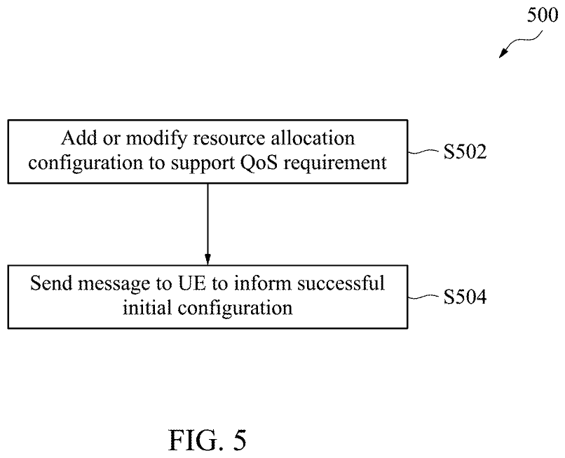

FIG. 5 is a flowchart illustrating a method 500 of an initial configuration at the network for the service reliability procedure in accordance with some embodiments of the disclosure. In Step S502, the network adds a new resource allocation configuration or modifies the existing resource allocation configuration to support the QoS requirement for XR data transmissions in response to the RRC message. The network may add a new resource allocation configuration or modify the existing resource allocation configuration in response to the RRC message from the mobile terminal. In particular, if there exists a protocol data unit (PDU) session, the network modifies the existing resource allocation configuration for the PDU session; else, the network adds a new resource allocation configuration with a trigger policy, e.g. based on HARQ feedback conditions. The network may choose or setup candidate connection(s) to meet the QoS requirement, depending on the measured channel quality(ies), e.g. channel quality index (CQI), reference signal received power (RSRP), received signal strength indicator (RSSI) and/or the like, and/or based on the bit error rate (BER) and/or the block error rate (BLER). Also, the network may setup candidate CG resources or semi-persistent scheduling (SPS) resources depending on the QoS requirement, e.g. the survival time, the delay budget and/or the priority, to determine the relative parameters, such as periodicity, priority and/or the like. In Step S504, the network sends a message to the mobile terminal to inform that it successfully accomplishes the initial configuration. Step S504 may be optional for some embodiments.

Referring back to FIG. 3, Step S304 is performed to determine whether the protocol layer procedure meets the QoS requirement for XR data transmissions between the network and the mobile terminal by considering the survival time parameter. The survival time parameter may be determined upon XR applications.

If the determination result of Step S304 indicates that the protocol layer procedure meets the QoS requirement by considering the survival time parameter, then Step S306 is performed to further determine whether the protocol layer procedure meets the QoS requirement for XR data transmissions between the network and the mobile terminal by considering XR-specific handling. XR-awareness information for XR-specific handling may include, but is not limited to, XR data periodicity, XR data size, XR data frame type, XR data identity, XR data level QoS parameters, number of PDUs for XR data, 5G QoS Indicators (5QI), jitter information (e.g. maximum and minimum values of the jitter), and/or the like. Particularly, the information of XR data size may include an average size and a size range of a set of PDUs, a start time of the first PDU in a set of PDUs, and/or an end indication or an indication of the last PDU in a set of PDUs; the information of XR data identity may include an identity of a set of PDUs and relationship information among the PDU in a set of PDUs; the XR data level QoS parameters may include a priority and a delay budget (e.g. via the air interface between the network and the mobile terminal) of a set of PDUs. Else, if the determination result of Step S304 indicates that the protocol layer procedure does not meet the QoS requirement by considering the survival time parameter, then Step S308 is performed to adopt the physical layer QoS handling mechanism without XR-specific handling consideration for XR data transmissions.

If the determination result of Step S306 indicates that the protocol layer procedure meets the QoS requirement for XR data transmissions between the network and the mobile terminal by considering XR-specific handling, then Step S310 is performed to adopt the protocol layer QoS handling mechanism with XR-specific handling consideration. Otherwise, if the determination result of Step S306 indicates that the protocol layer procedure does not meet the QoS requirement by considering XR-specific handling, then Step S312 is performed to adopt the physical layer QoS handling mechanism with XR-specific handling consideration. Following Step S310, in Step S314, the QoS requirement is used to determine whether to perform a network control based packet data convergence protocol (PDCP) duplication procedure or a user equipment (UE) control based PDCP duplication procedure. If the network control based PDCP duplication meets the QoS requirement for XR data transmissions, then Step S316 is performed, in which the network activates a network control based PDCP duplication procedure by sending a MAC control element (CE) to the mobile terminal for activating an RLC entity. The MAC CE may be used for indicating to support the QoS requirement for XR data transmissions. Otherwise, Step S318 is performed, in which the mobile terminal starts a UE control based PDCP duplication procedure by activating an RLC entity.

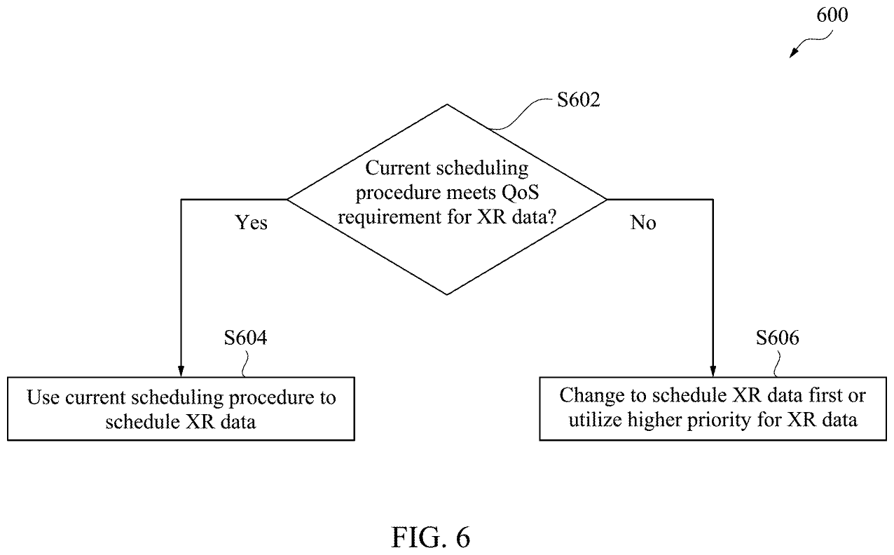

The protocol layer QoS handling mechanism with XR-specific handling consideration may be adjusted during XR data transmissions. FIG. 6 is a flowchart illustrating a method 600 of a protocol layer QoS handling mechanism with XR-specific handling consideration during XR data transmissions in accordance with some embodiments of the disclosure. In the method 600, Step S602 is performed to determine whether the current protocol layer scheduling procedure meets the QoS requirement for the XR data to be transmitted (e.g. a specific XR data with tight delay budget). If yes, then the procedure goes to Step S604, in which the current protocol layer scheduling procedure is used for the XR data without adjusting the protocol layer QoS handling mechanism; otherwise, Step S606 is performed, in which the protocol layer QoS handling mechanism is changed to schedule the XR data first or to utilize a higher priority for the XR data, in order to transmit the XR data as soon as possible.

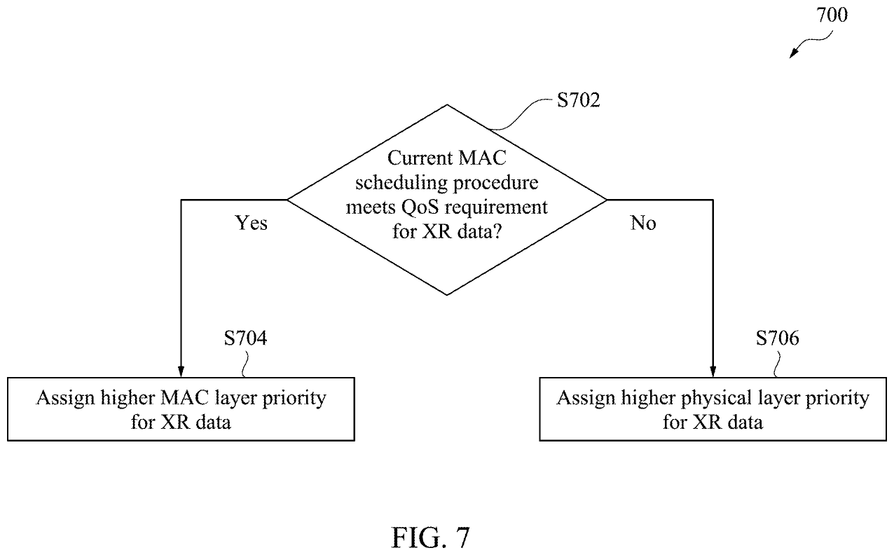

FIG. 7 is flowchart illustrating a method 700 of handling XR data transmissions for some exemplary examples. The method 700 may be applied to the physical layer QoS handling mechanism or the protocol layer QoS handling mechanism with or without XR-specific handling consideration for the embodiments of the disclosure. Particularly, in these exemplary examples, the MAC priority and the physical layer priority are utilized to handle prioritization of XR data for XR service applications. In the method 700, Step S702 is performed to determine whether the current MAC scheduling procedure with a higher priority meets the QoS requirement for the XR data to be transmitted. If yes, then the procedure goes to Step S704, in which a higher MAC priority is assigned for the XR data; otherwise, Step S706 is performed, in which a higher physical layer priority is assigned for the XR data. It is noted that a higher MAC priority and a higher physical layer priority may be simultaneously assigned for the XR data in some alternative examples.

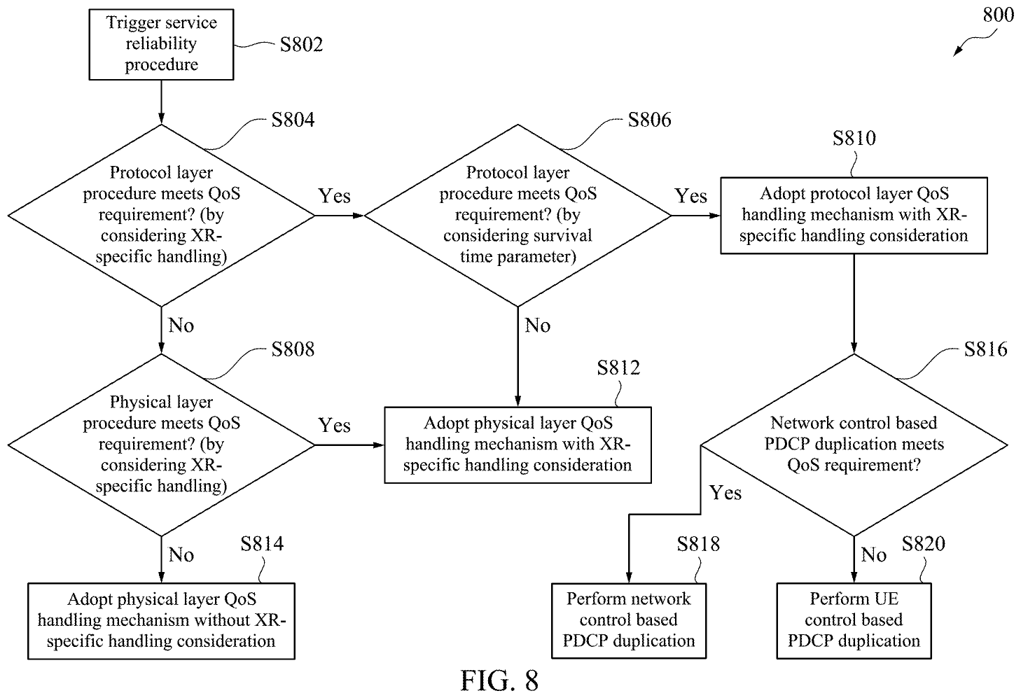

FIG. 8 is a flowchart illustrating a method 800 of a wireless communication system (e.g. the wireless communication system 102) for XR applications with enhanced QoS in order to avoid service interruptions due to survival time exceeded in accordance with some alternative embodiments of the disclosure. In Step S802, a service reliability procedure is triggered in response to a first network condition. Step S802 may be substantially the same as Step S302, and the initial configurations respectively at the mobile terminal and the network for the service reliability procedure of the method 800 may be substantially the same as those described above in accompany with FIGS. 4 and 5, and thus the detailed descriptions thereof are not repeated.

Step S804 is performed to determine whether the protocol layer procedure meets the QoS requirement for XR data transmissions between the network and the mobile terminal by considering XR-specific handling. If the determination result of Step S804 indicates that the protocol layer procedure meets the QoS requirement for XR data transmissions between the network and the mobile terminal by considering XR-specific handling, then Step S806 is performed to further determine whether the protocol layer procedure meets the QoS requirement for XR data transmissions between the network and the mobile terminal by considering the survival time parameter. Otherwise, if the determination result of Step S804 indicates that the protocol layer procedure does not meet the QoS requirement by considering XR-specific handling, then Step S808 is performed to further determine whether the physical layer procedure meets the QoS requirement for XR data transmissions between the network and the mobile terminal by considering XR-specific handling.

If the determination result of Step S806 indicates that the protocol layer procedure meets the QoS requirement for XR data transmissions between the network and the mobile terminal by considering the survival time parameter, then Step S810 is performed to adopt the protocol layer QoS handling mechanism with XR-specific handling consideration. Otherwise, if the determination result of Step S806 indicates that the protocol layer procedure does not meet the QoS requirement by considering the survival time parameter, then Step S812 is performed to adopt the physical layer QoS handling mechanism with XR-specific handling consideration.

On the other hand, if the determination result of Step S808 indicates that the physical layer procedure meets the QoS requirement by considering XR-specific handling, then the procedure goes to Step S812, in which the physical layer QoS handling mechanism with XR-specific handling consideration is adopted for XR data transmissions. Else, if the determination result of Step S808 indicates that the physical layer procedure does not meet the QoS requirement by considering XR-specific handling, then Step S814 is performed to adopt the physical layer QoS handling mechanism without XR-specific handling consideration for XR data transmissions.

Following Step S810, in Step S816, the QoS requirement is used to determine whether to perform a network control based packet data convergence protocol (PDCP) duplication procedure or a user equipment (UE) control based PDCP duplication procedure. If the network control based PDCP duplication meets the QoS requirement for XR data transmissions, then Step S818 is performed, in which the network activates a network control based PDCP duplication procedure by sending a MAC control element (CE) to the mobile terminal for activating an RLC entity. The MAC CE may be used for indicating to support the QoS requirement for XR data transmissions. Otherwise, Step S820 is performed, in which the mobile terminal starts a UE control based PDCP duplication procedure by activating an RLC entity.

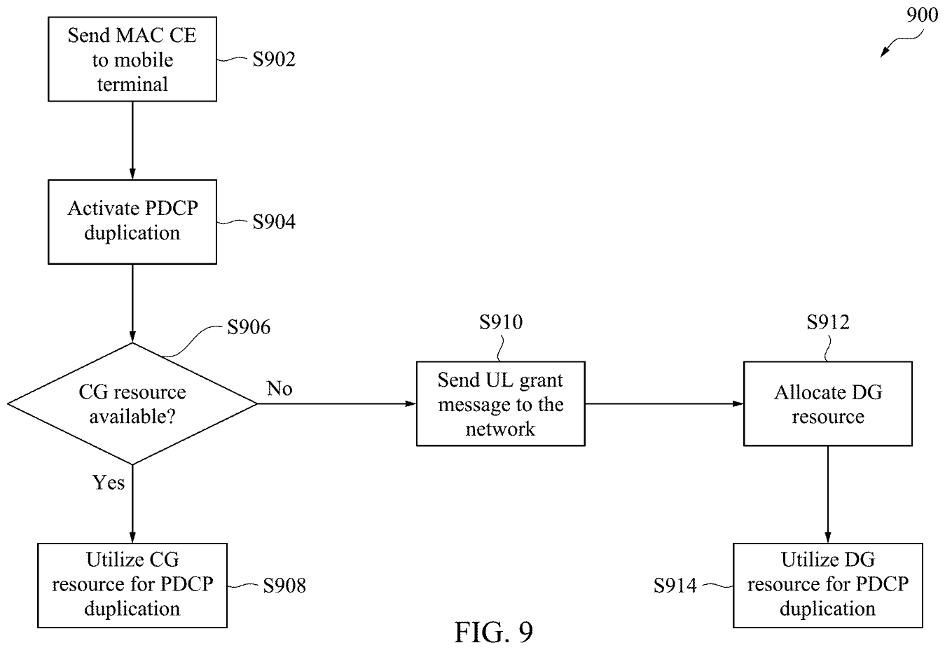

FIG. 9 is a flowchart illustrating a method 900 of a network control based PDCP duplication procedure that supports XR-specific features in accordance with some embodiments of the disclosure. In Step S902, the network sends a MAC CE to the mobile terminal to activate a specific RLC entity or plural specific RLC entities for specific uplink (UL) XR packets that belong to a DRB. In Step S904, the mobile terminal activates a PDCP duplication for the DRB. In Step S906, the mobile terminal determines whether a nearby allocated CG resource is available for use within the QoS requirement (e.g. delay budget of the specific UL XR packets). If yes, then Step S908 is performed, in which the CG resource allocated nearby the mobile terminal is utilized to perform a PDCP retransmission for the specific UL XR packets for the DRB. Otherwise, Step S910 is performed, in which the mobile terminal sends an UL grant message to the network to ask for a DG resource to perform a PDCP retransmission or transmission. In Step S912, in response to the UL grant message, the network allocates a DG resource toward the mobile terminal. Following Step S912, in Step S914, the mobile terminal utilizes the DG resource to perform a PDCP retransmission for the specific UL XR packets for the DRB. Also, the CG or DG resource for use within the QoS requirement can also be used to perform a new XR data transmission. In addition, the network can also enhance the downlink reliability by using available SPS resource or allocate new SPS resource for use within the QoS requirement to perform XR data retransmission or transmission.

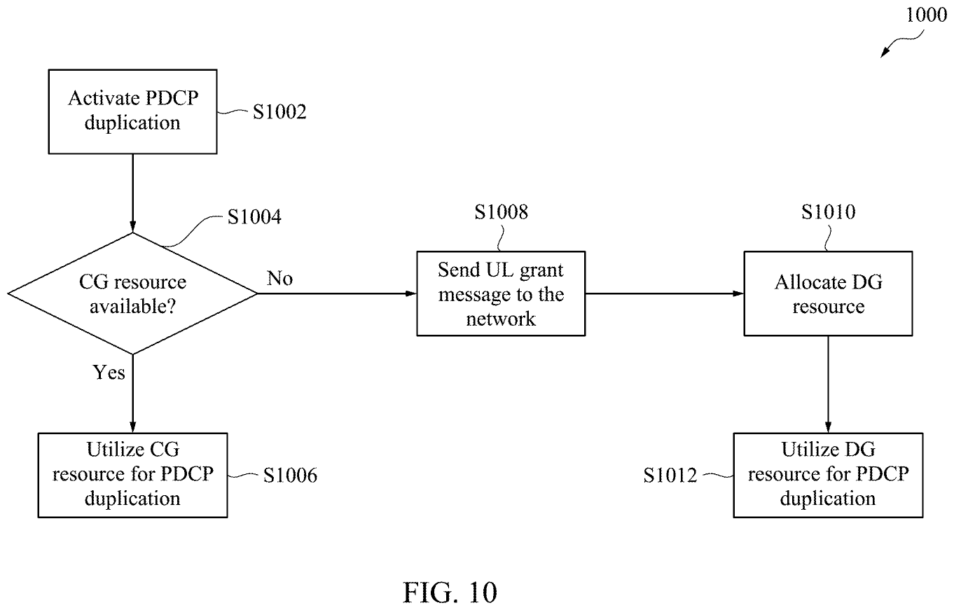

FIG. 10 is a flowchart illustrating a method 1000 of a UE control based PDCP duplication procedure that supports XR-specific features in accordance with some embodiments of the disclosure. In Step S1002, the mobile terminal activates a PDCP duplication for a DRB to which specific UL XR packets belong. In Step S1004, the mobile terminal determines whether a nearby allocated CG resource is available for use within the QoS requirement (e.g. delay budget of the specific UL XR packets). If yes, then Step S1006 is performed, in which the CG resource allocated nearby the mobile terminal is utilized to perform a PDCP retransmission for the specific UL XR packets for the DRB. Otherwise, Step S1008 is performed, in which the mobile terminal sends an UL grant message to the network to ask for a DG resource to perform a PDCP retransmission. In Step S1010, in response to the UL grant message, the network allocates a DG resource toward the mobile terminal. Following Step S1010, in Step S1012, the mobile terminal utilizes the DG resource to perform a PDCP retransmission for the specific UL XR packets for the DRB. In addition, the mobile terminal can also use CG or DG resource for use within the QoS requirement to perform a new XR data transmission.

For the physical layer QoS handling mechanism with XR-specific handling consideration, the transmission reliability may be improved by enhancing physical layer configurations at the mobile terminal and/or the network. In some embodiments, the physical layer QoS handling mechanism with XR-specific handling consideration may be performed by applying physical layer repetition to retransmit or transmit specific UL and/or DL XR data. The physical layer repetition may include CG physical uplink shared channel (PUSCH) repetition, SPS PUSCH repetition, DG PUSCH repetition, resource block (RB) repetition, and/or another suitable repetition.

In some embodiments, the physical layer QoS handling mechanism with XR-specific handling consideration may be performed by modifying a modulation and coding scheme (MCS) indication to retransmit or transmit specific UL and/or DL XR data, e.g., by downgrading the MCS to reduce the BER and/or the BLER.

In some embodiments, the physical layer QoS handling mechanism with XR-specific handling consideration may be performed by performing Bandwidth Part (BWP) switching (e.g. allowing to switch to different BWPs) and/or beam sweeping on the mobile terminal and/or the network to retransmit or transmit specific UL and/or DL XR data.

In some embodiments, the physical layer QoS handling mechanism with XR-specific handling consideration may be performed by using mini-slot(s) and/or adjusting the TTI (e.g. configuring a shorter TTI) to retransmit or transmit specific UL and/or DL XR data.

In some embodiments, the physical layer QoS handling mechanism with XR-specific handling consideration may be performed by utilizing frequency hopping, multi-input multi-output (MIMO), non-orthogonal multiple access (NOMA), or uplink preemption to retransmit or transmit specific UL and/or DL XR data with a high priority according to the type of the wireless communication system and the capabilities of the mobile terminal and/or the network.

The wireless communication system may introduce a new QoS parameter for XR data transmissions for a new MAC CE or an existing MAC CE. The new MAC CE may be extended based on CG/SPS configurations MAC CE or PDCP duplication MAC CE. In addition, the wireless communication system may introduce a MAC Protocol Data Unit (PDU) with a new extended logical channel ID (eLCID) value for a Downlink Shared Channel (DL-SCH) and/or an uplink shared channel (UL-SCH) for supporting activation and deactivation of the service reliability procedure.

The wireless communication system may introduce a hybrid automatic repeat request (HARQ) process ID to enhance the HARQ feedback procedure to meet the QoS requirement for XR data transmissions. The enhanced HARQ feedback procedure may be performed in the physical layer to support (e.g. start and/or stop or measure) HARQ processes, or may be performed an upper layer (e.g. MAC layer, RLC layer or PDCP layer) to support (e.g. start and/or stop or measure) acknowledgement/negative-acknowledgement (AC K/NAC K) processes. The base station may perform RRC configurations for the mobile terminal by exchange RRC messages with the mobile terminal for activating the service reliability procedure. Moreover, the core network in the network may perform core network configurations for the mobile terminal by exchange non-access stratum (NAS) messages with the mobile terminal for activating the service reliability procedure. In the network, the base station may exchange messages with the core network for activating the service reliability procedure.

The wireless communication system may introduce a new timer (e.g., a RRC timer) associated with the QoS requirement for a duration of transmission and/or retransmission. The new timer may be set to handle packet transmissions (e.g. XR data transmissions) during the service reliability procedure.

The wireless communication system may introduce a new priority indicator to handle prioritization between the specific UL and/or XR data and the other packets in the MAC layer and/or the physical layer. The new priority indicator may be set at the mobile terminal or the network to configure transmission priorities during the service reliability procedure.

The wireless communication system may introduce a new periodicity value or plural new periodicity values associated with the QoS requirement for transmission and/or retransmission periodicity. The new periodicity value(s) may be set at the mobile terminal or the network to handle packet transmissions and/or retransmissions during the service reliability procedure.

The wireless communication system may introduce new UE capability information for notifying support of the QoS requirement for XR data transmissions. The new UE capability information may be configured at the mobile terminal to support the QoS requirement during the service reliability procedure.

The wireless communication system may introduce a new transmission time interval (TTI), a new periodicity or a new priority or a new indicator for enabling physical layer repetition and/or MCS for the QoS requirement. The new TTI may be shorter than the original TTIs, the periodicity may be shorter than the original periodicities, the new priority may be higher than the original priorities, and the new indicator may be used to enable physical layer repetition and/or MCS for specific UL and/or DL XR data. The new TTI, the new periodicity, the new priority and/or the new indicator may be applied for XR data transmissions during the service reliability procedure.

The PDCP duplication may be stopped in response to a second network condition. The second network condition may be any condition in which the PDCP duplication can be stopped, e.g., a retransmission packet or a number of consecutive correct retransmission packets is/are correctly received, a retransmission packet or a number of consecutive retransmission packets is/are all received according to the HARQ feedback conditions, or the next new transmission packet or a number of consecutive transmission packets is/are received. The PDCP duplication may be stopped by the mobile terminal or the network. If a UE control based PDCP duplication stopping procedure is adopted, the mobile terminal may disable the activated RLC entity(ies) or disable packet duplication corresponding to the activated RLC entity(ies). The UE control based PDCP duplication stopping procedure may be performed without notifying the network. If a network control based PDCP duplication stopping procedure is adopted, the network sends a MAC CE to the mobile terminal for indicating which RLC entity(ies) is/are to be disabled, and then the mobile terminal disables the RLC entity(ies) or disable packet duplication corresponding to the RLC entity(ies) accordingly.

The PDCP duplication may be deactivated by the network in response to a third network condition. The third network condition may be any condition in which the PDCP duplication can be deactivated, e.g., the QoS service is no longer required, the QoS service is not supported, or the PDCP duplication function is unavailable. The network may send an RRC message to the mobile terminal for deactivating the PDCP duplication.

In the wireless communication system according to the embodiments of the disclosure, a handling mechanism similar to intra-UE prioritization is applied to meet the QoS requirement for new XR data with a higher priority or the highest priority. When detecting transmission error(s), the mobile terminal or the network enables the functionality of QoS requirement support. The mobile terminal may duplicate the PDUs of the lost packets and performs an autonomous retransmission or a new transmission with the higher or highest propriety for the packets. The mobile terminal may select available allocated CG resource(s) to send the packets. Alternatively, the mobile terminal may issue a prioritized UL grant message and selects DG resource(s) to send packets, or else may utilize the DG resource(s) indicated by the network to send packets. The duplication may be performed for different RLC entities, for specific packets and/or both.

Similarly, the mobile terminal may duplicate the PDUs of the lost packets and performs an autonomous retransmission or a new transmission with the higher or highest priority for the packets. The network may select available allocated SPS resource(s) or allocate new SPS resource(s) to send packets. The duplication may be performed for different RLC entities, for specific packets and/or both.

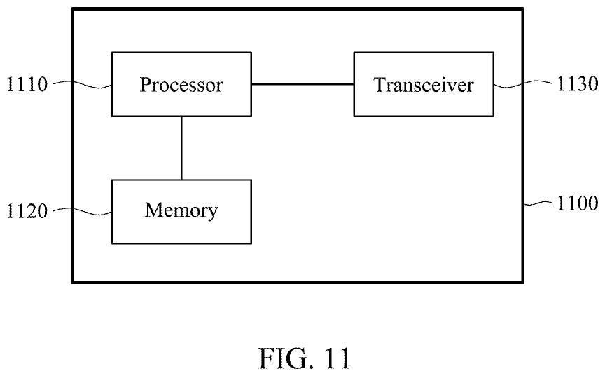

Referring to FIG. 11, which illustrates a block diagram of an apparatus 1100 in accordance with some embodiments of the disclosure. Each of the UE 110, the RAN 120 and/or another entity (e.g. the UPF 130) within the wireless communication system 102 and/or the DN 140 external to the wireless communication system 102 shown in FIG. 1 may have a block diagram similar to that of the apparatus 1100. The apparatus 1100 includes a processor 1110, a memory 1120 and a transceiver 1130. The processor 1110 may be, for example, a conventional processor, a digital signal processor (DSP), a microprocessor or an application-specific integrated circuit (ASIC), but is not limited thereto. The memory 1120 may be any data storage device which may be read and executed by the processor 1110. The memory 1120 may be, for example, a subscriber identity module (SIM), a read-only memory (ROM), an erasable programmable ROM (EPROM), an electrically erasable programmable ROM (EEPROM), a random access memory (RAM), a CD-ROM, a magnetic tape, a hard disk, a solid state disk (SSD), a flash memory or other data storage device suitable for storing a program code, but is not limited thereto. The transceiver 1130 may be a radio transceiver for performing wireless communications with a remote entity based on the operation result of the processor 1110. For example, if the apparatus 1100 is the UE 110 in FIG. 1, the transceiver 1130 performs wireless communications with the RAN 120; if the apparatus 1100 is the RAN 120 in FIG. 1, the transceiver 1130 performs wireless communications with the UE 110. The processors of the UE 110 and/or the RAN 120 may perform the methods 300, 400, 500, 600, 700, 800, 900, 1000 by executing the instructions stored in the memory thereof.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims.

What is claimed is:

1. A method of a wireless communication system for extended reality (XR) applications, comprising:
triggering a service reliability procedure with activating an XR-specific handling procedure in response to a first network condition; and
determining whether to perform a protocol layer quality of service (QoS) handling mechanism with XR-specific handling consideration, a physical layer QoS handling mechanism with XR-specific handling consideration, or a physical layer QoS handling mechanism without XR-specific handling consideration to enhance QoS between a network and a mobile terminal depending on a QoS requirement for XR data transmissions.

2. The method of claim 1, wherein performing the protocol layer QoS handling mechanism with XR-specific handling consideration comprises:
activating, at the mobile terminal, a radio link control (RLC) entity for a packet data convergence protocol (PDCP) duplication; and
determining, by the mobile terminal, whether a configured grant (CG) resource allocated nearby the mobile terminal is available for use within the QoS requirement for XR data transmissions, and if yes, utilizing the CG resource to perform a PDCP retransmission or transmission; otherwise, sending an uplink (UL) grant message to the network to ask for a dynamic grant (DG) resource to perform a PDCP retransmission or transmission.

3. The method of claim 2, wherein performing the protocol layer QoS handling mechanism with XR-specific handling consideration further comprises:
sending, by the network, a media access control (MAC) control element (CE) to the mobile terminal for activating the RLC entity in response to the first network condition.

4. The method of claim 3, wherein the MAC CE is extended based on a CG/SPS configurations MAC CE or a PDCP duplication MAC CE for indicating to support the QoS requirement for XR data transmissions.

5. The method of claim 2, further comprising:
stopping, by the mobile terminal, the PDCP duplication in response to a second network condition.

6. The method of claim 5, further comprising:
sending, by the network, a MAC CE to the mobile terminal for stopping the PDCP duplication in response to the second network condition.

7. The method of claim 2, wherein the network sends a radio resource control (RRC) message to the mobile terminal for deactivating the PDCP duplication in response to a third network condition.

8. The method of claim 1, wherein XR-awareness information for the protocol layer QoS handling mechanism with XR-specific handling consideration comprises XR data periodicity, XR data size, XR data frame type, XR data identity, XR data level QoS parameters, number of PDUs for XR data, 5G QoS Indicators (5QI) or jitter information.

9. The method of claim 1, wherein performing the physical layer QoS handling mechanism with XR-specific handling consideration comprises applying physical layer repetition to retransmit or transmit XR data.

10. The method of claim 9, wherein the physical layer repetition comprises at least one of CG physical uplink shared channel (PUSCH) repetition, DG PUSCH repetition or resource block (RB) repetition.

11. The method of claim 1, wherein performing the physical layer QoS handling mechanism with XR-specific handling consideration comprises modifying a modulation and coding scheme (MCS) indication to retransmit or transmit XR data.

12. The method of claim 1, wherein performing the physical layer QoS handling mechanism comprises performing Bandwidth Part (BWP) switching and/or beam sweeping on the mobile terminal and/or the network to retransmit or transmit XR data.

13. The method of claim 1, wherein performing the physical layer QoS handling mechanism with XR-specific handling consideration comprises using one or more mini-slots or adjusting a transmission time interval (TTI) to retransmit or transmit specific XR data.

14. The method of claim 1, wherein performing the physical layer QoS handling mechanism comprises utilizing frequency hopping, multi-input multi-output (MIMO), non-orthogonal multiple access (NOMA), or uplink preemption to retransmit or transmit a data packet for high priority transmission.

15. The method of claim 1, further comprising:
utilizing a MAC Protocol Data Unit (PDU) with an extended logical channel ID (eLCID) value for a Downlink Shared Channel (DL-SCH) or an uplink shared channel (UL-SCH) for supporting activation and deactivation of the service reliability procedure.

16. The method of claim 1, further comprising:
determining whether a current protocol layer scheduling procedure meets the QoS requirement for specific XR data with tight delay budget, and if yes, using the current protocol layer scheduling procedure for the specific XR data without adjusting the protocol layer QoS handling mechanism; otherwise, changing the protocol layer QoS handling mechanism to schedule the specific XR data first or to utilize a higher priority for the specific XR data.

17. The method of claim 1, further comprising:
determining whether a current MAC scheduling procedure with a higher priority meets the QoS requirement for specific XR data, and if yes, assigning a higher MAC priority for the specific XR data; otherwise, assigning a higher physical layer priority for the specific XR data.

18. The method of claim 1, further comprising:
configuring user equipment (UE) capability information to support the QoS requirement for XR data transmissions during the service reliability procedure.

19. The method of claim 1, further comprising:
adjusting a TTI, a periodicity or a priority, or enabling physical layer repetition and/or MCS for packet transmissions during the service reliability procedure.

20. The method of claim 1, wherein triggering the service reliability procedure comprises:
sending, from the mobile terminal, an RRC message to the network for indicating that the mobile terminal supports the QoS requirement for XR data transmissions; and
adding or modifying, at the network, a resource allocation configuration to support the QoS requirement for XR data transmissions.
